(19) United States
(12) Patent Application Publication
(10) Pub. No.: US 2023/0103648 A1
(43) Pub. Date: Apr. 6, 2023

(54) ADHESIVE DISPENSER AND DISPENSING NOZZLE

(71) Applicant: T.A. Systems, Inc., Rochester Hills, MI (US)

(72) Inventors: Hendrik Stoltz, Dryden, MI (US); Bruce Bennett, Clarkston, MI (US)

(21) Appl. No.: 17/952,396

(22) Filed: Sep. 26, 2022

Related U.S. Application Data
(60) Provisional application No. 63/252,720, filed on Oct. 6, 2021.

(51) Int. Cl. B05C 11/10; B05C 5/02; B01F 25/00

(52) U.S. Cl. CPC B05C 11/1036; B05C 5/0225; B05C 11/1026; B01F 25/105; B01F 2101/36

(57) ABSTRACT

An adhesive dispenser includes a support structure, a valve body that is mounted to the support structure and is configured to receive at least first and second adhesive materials, and a nozzle assembly that is connected to the valve body. The nozzle assembly includes a rigid tube that extends from the valve body to a tube end, and a mixing insert that is received within the tube and extends to an insert end. The mixing insert is configured to receive the first and second adhesive materials from the valve body for intermixing upstream from the insert end. The dispenser further includes a nozzle that is supported relative to the support structure and arranged about the tube end and the insert end. The nozzle has an opening at a terminal end, and a shaped aperture adjoins the opening. The nozzle is configured to dispense intermixed adhesive through the opening and aperture onto a component.

### CROSS-REFERENCE TO RELATED APPLICATIONS

This application claims priority to U.S. Provisional Application No. 63/252,720 filed on Oct. 6, 2021, and is incorporated herein by reference in its entirety.

### TECHNICAL FIELD

This disclosure relates to an adhesive dispensing system used to apply an adhesive on a component such as automotive glass.

### BACKGROUND

Adhesive dispensing systems are relatively commonplace for a variety of applications. Such systems are relatively straightforward for single component adhesives. However, a two-part adhesive requires a static mixer to extrude a fully intermixed adhesive into a bead. Two-part adhesive dispensing systems provide a variety of challenges that are not presently overcome.

### SUMMARY

In one exemplary embodiment, an adhesive dispenser includes a support structure, a valve body that is mounted to the support structure and is configured to receive at least first and second adhesive materials, and a nozzle assembly that is connected to the valve body. The nozzle assembly includes a rigid tube that extends from the valve body to a tube end, and a mixing insert that is received within the tube and extends to an insert end. The mixing insert is configured to receive the first and second adhesive materials from the valve body for intermixing upstream from the insert end. The dispenser further includes a nozzle that is supported relative to the support structure and arranged about the tube end and the insert end. The nozzle has an opening at a terminal end, and a shaped aperture adjoins the opening. The nozzle is configured to dispense intermixed adhesive through the opening and aperture onto a component.

In a further embodiment of any of the above, the tube is threaded onto the valve body, and the tube is metallic.

In a further embodiment of any of the above, the mixing insert is a plastic.

In a further embodiment of any of the above, the nozzle is a plastic.

In a further embodiment of any of the above, the aperture is a V-shaped notch that has a radiused and tapered ledge that adjoins an interior surface of the nozzle.

In a further embodiment of any of the above, the mixing insert includes an annular tapered outer diameter that abuts and seals against an annular ledge of an interior surface of the nozzle.

In a further embodiment of any of the above, the tube and the mixing insert are fixed relative to valve body, and first and second flexible hoses respectively supply each of at least first and second adhesive materials to the valve body.

In a further embodiment of any of the above, the nozzle is rotatable relative to the mixing insert and slidable at an interface between the annular tapered outer diameter and the annular ledge.

In another exemplary embodiment, a nozzle assembly includes a rigid tube that extends to a tube end, and a mixing insert that is received within the tube and extends to an insert end. The mixing insert is configured to receive and intermix an adhesive, and a nozzle is arranged about the tube end and the insert end. The nozzle has an opening at a terminal end, and a shaped aperture adjoins the opening. The nozzle is configured to dispense the adhesive through the opening and aperture onto a component.

In a further embodiment of any of the above, the tube, the mixing insert and the nozzle are coaxial with one another.

In a further embodiment of any of the above, the tube is metallic, the mixing insert is a first plastic, and the nozzle is a second plastic different than the first plastic.

In a further embodiment of any of the above, the aperture is a V-shaped notch that has a radiused edge that adjoins an interior surface of the nozzle.

In a further embodiment of any of the above, the mixing insert includes an annular tapered outer diameter that abuts and seals against an annular ledge of an interior surface of the nozzle.

In another exemplary embodiment, an adhesive dispensing cell includes an automated component handler that is configured to position a component in a desired orientation. The cell further includes an adhesive dispenser that has a nozzle assembly that includes a mixing insert that is configured to receive an adhesive and has an insert end, and a nozzle that is arranged about the insert end. The nozzle has an opening at a terminal end, and a shaped aperture that adjoins the opening. The nozzle is configured to dispense the adhesive through the opening and aperture onto a component that is arranged in the desired orientation.

In another exemplary embodiment, the cell includes a support structure, a valve body that is mounted to the support structure and is configured to receive an adhesive material to be provided to the mixing insert.

In another exemplary embodiment, the automated component handler is a multi-axis robot, and includes a frame to which the valve body is mounted. The mixing insert and the nozzle are fixed relative to the frame.

In another exemplary embodiment, the robot is configured to move the component relative to the opening and the aperture during deposition of the adhesive onto the component.

In another exemplary embodiment, the automated component handler is a feed mechanism that is configured to move the component in no more than two directions, and the nozzle is rotatable relative to the component during deposition of the adhesive onto the component.

In another exemplary embodiment, the mixing insert includes an annular tapered outer diameter that abuts and seals against an annular ledge of an interior surface of the nozzle. The nozzle is rotatable relative to the mixing insert and slidable at an interface between the annular tapered outer diameter and the annular ledge.

In another exemplary embodiment, the nozzle assembly includes a rigid tube that is secured to the valve body and extends to a tube end. The mixing insert is received within the tube, and the nozzle is arranged about the tube end.

### BRIEF DESCRIPTION OF THE DRAWINGS

The disclosure can be further understood by reference to the following detailed description when considered in connection with the accompanying drawings wherein:

FIG. 1 is a schematic of an example adhesive dispensing cell.

FIG. 2 depicts a valve body for the system of FIG. 1 with a nozzle assembly according to the disclosure.

FIG. 3 is a cross-sectional view of the dispenser and nozzle assembly shown in FIG. 2.

FIG. 4 is an enlarged view of the end portion of the nozzle assembly shown in FIG. 3.

FIG. 5 is another example adhesive dispensing cell.

FIG. 6 is a perspective view of a dispensing station suitable for the system shown in FIG. 5.

FIG. 7 is an enlarged end view of the nozzle assembly used in the dispensing station shown in FIG. 6.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

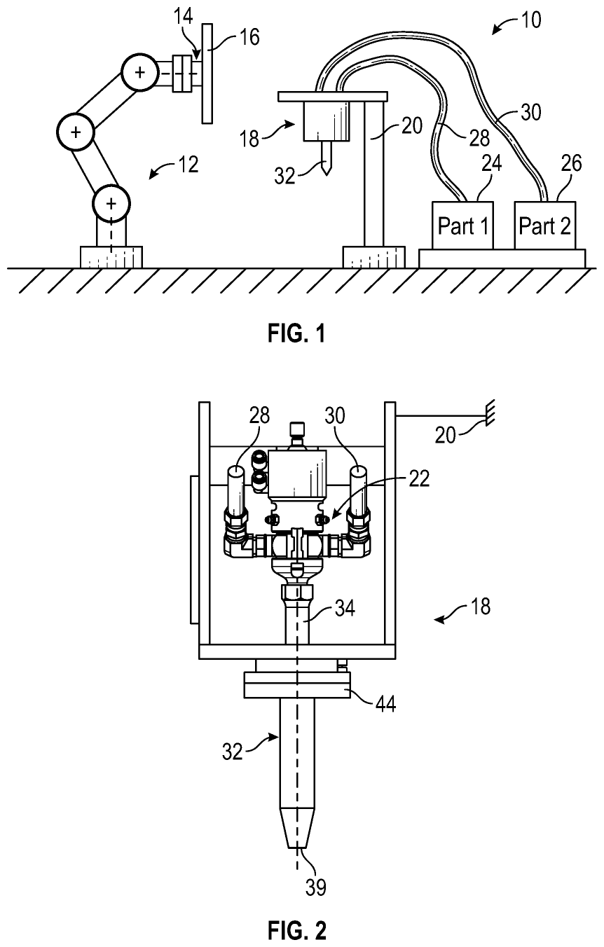

An adhesive dispensing cell 10 includes an automated component handler such as a multi-axis robot 12, as shown in FIG. 1. The robot 12 has an end effector with a fixture 14 for holding a component 16. In the example, the component 16 may be automotive glass, however it should be understood that the component may be any part or assembly used in the automotive industry or any other industry.

The robot 12 is programmed to orient the component 16 in a desired position beneath an adhesive dispensing station 18, which is fixed in the example. The station 18 includes a frame 20 to which a valve body 22 is mounted. The valve body 22, best shown in FIG. 2, receives first and second adhesive materials 24, 26 that are mixed within a nozzle assembly 32 before dispensing a bead of the intermixed adhesive onto the component 16. More or fewer adhesives may be used. The adhesives are typically carried to the valve body 22 by first and second flexible hoses 28, 30, that respectively supply the first and second adhesives 24, 26 to the nozzle assembly 32. It is desirable to keep the first and second hoses 28, 30 stationary such that they do not flex, as flexing the hoses can change the pressures within the system and adversely affect the dispensing and mixing of the adhesive.

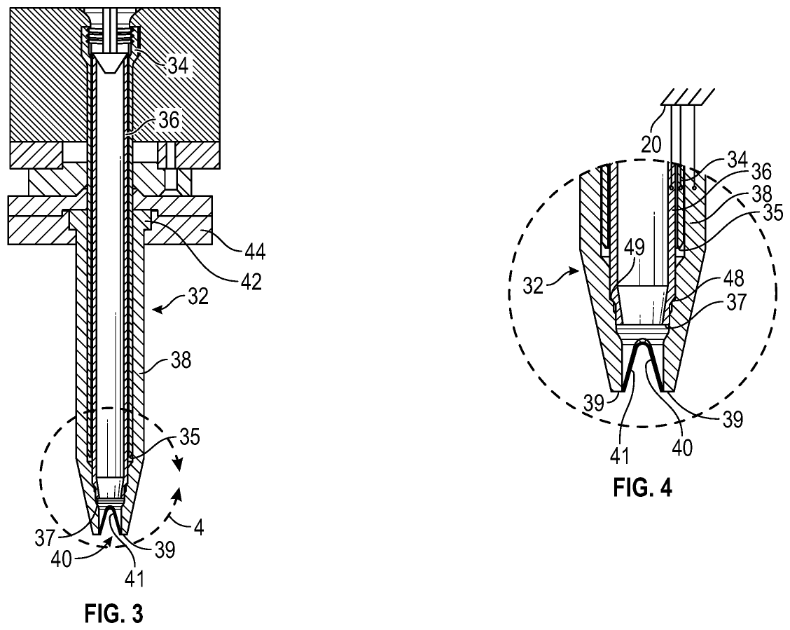

Referring to FIGS. 2 and 3, the nozzle assembly 32 is constructed from three concentric cylindrically walled members in the example, although fewer or more members than shown may be used. In the example, the nozzle assembly 32 includes a plastic mixing insert 36 which receives the first and second adhesives 24, 26. The interior surface of the mixing insert 36 may include protrusions or other structures that increase mixing of the adhesives before they are dispensed onto the component. The mixing insert 36, which may be an inexpensive polypropylene or polyethylene, is discarded and replaced or cleaned and re-used at regular intervals during a production schedule, for example, at the end of a shift.

Referring to FIG. 4, the nozzle assembly 32 also includes a metallic tube 34 (e.g., steel) arranged adjacent to an outside of the mixing insert 36 to provide structural support to the mixing insert 36, which is subjected to great pressure from the adhesives during the dispensing process. The tube 34 is fastened to an end of the valve body 22, for example by threads. However, a quick connect disconnect feature could be provided for the connection to the valve body 22.

The nozzle assembly 32 also provides a plastic nozzle 38 receiving an insert end 37 of the mixing insert 36. In one example, the nozzle 38 is a 3-D printed part which can be cleaned at various intervals and reused. Printing the nozzle 38 from a nylon or HDPE with a carbon fill that can provide a part with a strength similar to that of aluminum, which is fairly durable for the application. The nozzle 38 can also be injected molded or formed by other processes depending upon cost, materials and other design considerations. The nozzle 38 includes an opening 40 at a terminal end 39 of the nozzle 38 having an adjoining shaped aperture, such as a V-shaped notch 41, which forms the adhesive bead. The notch 41 includes a radius and tapered straight edges towards inner diameter of the nozzle 38 that facilitates desired flow of the adhesive when dispensing the adhesive onto the component to provide a desired bead shape. In another example, the base of the nozzle 38 can be provided as a flattened out area to a point, which ensures proper back pressure in such a way that manufacturing in a conventional non-3D printed way would be nearly impossible.

In the example, the mixing insert 36 includes an annular tapered outer diameter 48 abutting and sealing against an annular ledge 49 of the interior surface of the nozzle 38. This prevents adhesive from migrating outside of the interface between the mixing insert 36 and the nozzle 38. An end of the nozzle 38 opposite the terminal end 39 includes a collar 42 captured by a plate 44 which prevents rotation of the nozzle 38 during a dispensing, while also permitting disassembly for cleaning.

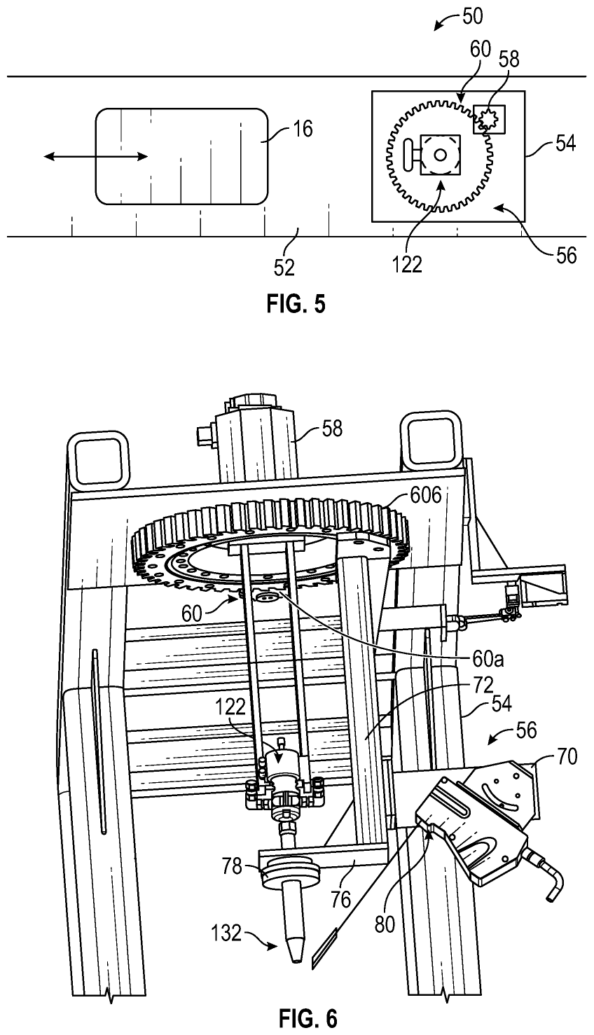

Another example adhesive dispensing cell 50 is schematically illustrated in FIG. 5. The cell 50 includes an automated component handler or feed mechanism, such as a conveyor 52 that moves the component 16 along a linear path to a desired orientation with respect to the dispensing station 56. The feed mechanism may also move the component laterally. This may be reversed so that the component is held stationary and the material handler moves the nozzle in an X-Y-Z cartesian fashion. In such a configuration, the nozzle would be rotated to obtain desired bead orientation.

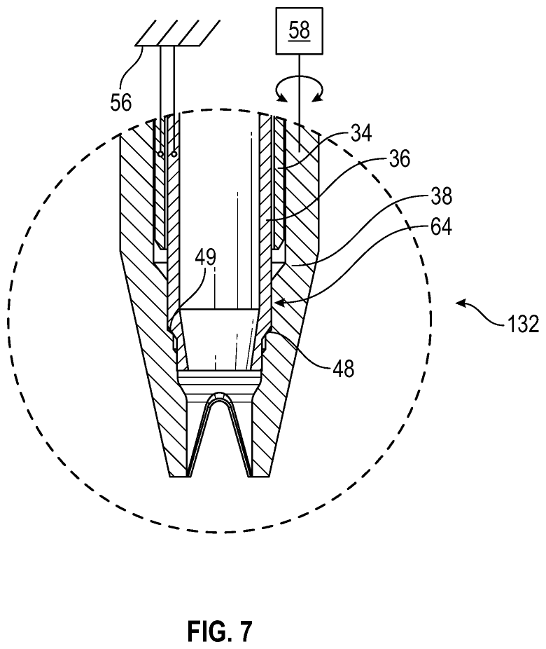

An underside of the dispensing station 56 is shown in FIG. 6. The station 56 includes a fixed frame 54 supporting an actuator 58 that rotational drives a gear system 60 including a drive gear 60a and a driven gear 60b. The valve body 122 is fixed in relation to the frame 54 to prevent flex of the adhesive hoses. In this example, the nozzle assembly 132, shown in FIG. 7, has its nozzle 38 rotatable in response to movement imparted by the actuator 58. This enables the nozzle 38 to rotate relative to the mixing insert 36 at sliding interface 64 between the annular tapered outer diameter 48 and the annular ledge 49.

In operation, the nozzle 38 is mounted to a ring 78 supported by a bracket 76. The bracket 76 is secured to a bracket 72 that is mounted relative to the driven gear 60b. If desired, the bracket 72 can include a slide (not shown) that moves the nozzle assembly 132 vertically with respect to the component 16 when dispensing adhesive. Rotation of the driven gear 60b rotates the ring 78, which in turn rotates the nozzle 38 to change the orientation of the notch 41 relative to the component 16 when dispensing the adhesive. A vision system having a camera 80 mounted to the bracket 72 via a mounting flange 70 may be used to monitor the position of the component 16, the orientation of the nozzle 38, and/or the presence, absence or quality of the adhesive being dispensed.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. An adhesive dispenser comprising:
a support structure;
a valve body mounted to the support structure and configured to receive at least first and second adhesive materials; and
a nozzle assembly connected to the valve body, the nozzle assembly including:
a rigid tube extending from the valve body to a tube end;
a mixing insert received within the tube and extending to an insert end, the mixing insert configured to receive the first and second adhesive materials from the valve body for intermixing upstream from the insert end; and
a nozzle supported relative to the support structure and arranged about the tube end and the insert end, the nozzle having an opening at a terminal end, and a shaped aperture adjoining the opening, the nozzle configured to dispense intermixed adhesive through the opening and aperture onto a component.

2. The dispenser of claim 1, wherein the tube is threaded onto the valve body, and the tube is metallic.

3. The dispenser of claim 1, wherein the mixing insert is a plastic.

4. The dispenser of claim 1, wherein the nozzle is a plastic.

5. The dispenser of claim 1, wherein the aperture is a V-shaped notch having a radiused and tapered ledge adjoining an interior surface of the nozzle.

6. The dispenser of claim 1, wherein the mixing insert includes an annular tapered outer diameter abutting and sealing against an annular ledge of an interior surface of the nozzle.

7. The dispenser of claim 6, wherein the tube and the mixing insert are fixed relative to valve body, and first and second flexible hoses respectively supply each of at least first and second adhesive materials to the valve body.

8. The dispenser of claim 6, wherein the nozzle is rotatable relative to the mixing insert and slidable at an interface between the annular tapered outer diameter and the annular ledge.

9. A nozzle assembly comprising:
a rigid tube extending to a tube end;
a mixing insert received within the tube and extending to an insert end, the mixing insert configured to receive and intermix an adhesive; and
a nozzle arranged about the tube end and the insert end, the nozzle having an opening at a terminal end, and a shaped aperture adjoining the opening, the nozzle configured to dispense the adhesive through the opening and aperture onto a component.

10. The nozzle assembly of claim 9, wherein the tube, the mixing insert and the nozzle are coaxial with one another.

11. The nozzle assembly of claim 9, wherein the tube is metallic, the mixing insert is a first plastic, and the nozzle is a second plastic different than the first plastic.

12. The nozzle assembly of claim 9, wherein the aperture is a V-shaped notch having a radiused edge adjoining an interior surface of the nozzle.

13. The nozzle assembly of claim 9, wherein the mixing insert includes an annular tapered outer diameter abutting and sealing against an annular ledge of an interior surface of the nozzle.

14. An adhesive dispensing cell comprising:
an automated component handler configured to position a component in a desired orientation; and
an adhesive dispenser having a nozzle assembly including:
a mixing insert configured to receive an adhesive and having an insert end; and
a nozzle arranged about the insert end, the nozzle having an opening at a terminal end, and a shaped aperture adjoining the opening, the nozzle configured to dispense the adhesive through the opening and aperture onto a component arranged in the desired orientation.

15. The cell of claim 14, comprising a support structure, a valve body mounted to the support structure and configured to receive an adhesive material to be provided to the mixing insert.

16. The cell of claim 15, wherein the automated component handler is a multi-axis robot, and comprising a frame to which the valve body is mounted, the mixing insert and the nozzle are fixed relative to the frame.

17. The cell of claim 16, wherein the robot is configured to move the component relative to the opening and the aperture during deposition of the adhesive onto the component.

18. The cell of claim 15, wherein the automated component handler is a feed mechanism configured to move the component in no more than two directions, and the nozzle is rotatable relative to the component during deposition of the adhesive onto the component.

19. The cell of claim 18, wherein the mixing insert includes an annular tapered outer diameter abutting and sealing against an annular ledge of an interior surface of the nozzle, the nozzle is rotatable relative to the mixing insert and slidable at an interface between the annular tapered outer diameter and the annular ledge.

20. The cell of claim 14, wherein the nozzle assembly includes a rigid tube secured to the valve body and extending to a tube end, the mixing insert received within the tube, and the nozzle arranged about the tube end.
